(19) United States
(12) Patent Application Publication
(10) Pub. No.: US 2022/0075369 A1
(43) Pub. Date: Mar. 10, 2022

(54) MACHINE LEARNING WITH SENSOR INFORMATION RELEVANT TO A LOCATION OF A ROADWAY

(71) Applicant: Micron Technology, Inc., Boise, ID (US)

(72) Inventors: Fatma Arzum Simsek-Ege, Boise, ID (US); Deepti Verma, Boise, ID (US); Anshika Sharma, Boise, ID (US); Lavanya Sriram, Boise, ID (US); Trupti D. Gawai, Boise, ID (US)

(21) Appl. No.: 17/013,185

(22) Filed: Sep. 4, 2020

(51) Int. Cl. G05D 1/00; G05B 13/02; G07C 5/00; G07C 5/08

(52) U.S. Cl. CPC G05D 1/0027; G07C 5/0808; G07C 5/008; G05B 13/0265

(57) ABSTRACT

Apparatuses, and methods related machine learning (ML) with sensor information relevant to a location of a roadway are described. Memory systems including processing resource and memory resources receive sensor information from a sensor associated with a vehicle and a relevant to a location on a roadway. The received sensor information from the vehicle can be operated upon, using a ML algorithm, and an instruction can be transmitted based on ML algorithm. In an example, a method can include receiving, at a processing resource, sensor information from a sensor associated with a first vehicle and relevant to a location on a roadway, operating on the received sensor information associated with the first vehicle using a ML algorithm stored in a memory resource accessible by the processing resource, transmitting instructions relevant to the location, based on the sensor information associated with the first vehicle that was operated upon by the ML algorithm.

### TECHNICAL FIELD

The present disclosure relates generally to semiconductor memory and methods, and more particularly, to methods and systems related to transmitting instructions relevant to a location of a vehicle on a roadway.

### BACKGROUND

Memory resources are typically provided as internal, semiconductor, integrated circuits in computers or other electronic systems. There are many different types of memory, including volatile and non-volatile memory. Volatile memory can require power to maintain its data (e.g., host data, error data, etc.). Volatile memory can include random access memory (RAM), dynamic random access memory (DRAM), static random access memory (SRAM), synchronous dynamic random access memory (SDRAM), and thyristor random access memory (TRAM), among other types. Non-volatile memory can provide persistent data by retaining stored data when not powered. Non-volatile memory can include NAND flash memory, NOR flash memory, and resistance variable memory, such as phase change random access memory (PCRAM) and resistive random access memory (RRAM), ferroelectric random access memory (FeRAM), and magnetoresistive random access memory (MRAM), such as spin torque transfer random access memory (STT RAM), among other types.

Electronic systems often include a number of processing resources (e.g., one or more processing resources), which may retrieve instructions from a suitable location and execute the instructions and/or store results of the executed instructions to a suitable location (e.g., the memory resources). A processing resource can include a number of functional units such as arithmetic logic unit (ALU) circuitry, floating point unit (FPU) circuitry, and a combinatorial logic block, for example, which can be used to execute instructions by performing logical operations such as AND, OR, NOT, NAND, NOR, and XOR, and invert (e.g., NOT) logical operations on data (e.g., one or more operands). For example, functional unit circuitry may be used to perform arithmetic operations such as addition, subtraction, multiplication, and division on operands via a number of operations.

Sensors such as wheel speed, steering, and/or machine vision sensors, etc. are becoming more widely implemented in vehicles. The vehicles may be driver operated, driver-less (e.g., autonomous vehicles), and/or partially autonomous vehicles. Memory can be used heavily in connection with such sensors in vehicles.

### BRIEF DESCRIPTION OF THE DRAWINGS

FIG. 1 illustrates a system diagram wirelessly connecting a plurality of vehicles relevant to a location of a roadway in accordance with a number of embodiments of the present disclosure.

FIG. 2 illustrates a system diagram wirelessly connecting a plurality of vehicles relevant to a location of a roadway in accordance with a number of embodiments of the present disclosure.

FIG. 3 is a diagram of a computing system including multiple memory resources in accordance with a number of embodiments of the present disclosure.

FIG. 4 is a diagram of a computing system including a memory system deployed on a host in the form of a vehicle in accordance with a number of embodiments of the present disclosure.

FIG. 5 is a block diagram illustrating an example system for sharing sensor information between hosts using wireless connection points in accordance with a number of embodiments of the present disclosure.

FIG. 6 is flow diagram representing an example method of machine learning with sensor information relevant to a location of a roadway in accordance with a number of embodiments of the present disclosure.

### DETAILED DESCRIPTION

The present disclosure includes methods and systems related to machine learning with sensor information relevant to a location of a roadway. For example, memory may be used extensively in vehicles in connection with vehicle sensors for operation of the vehicle. The vehicle may be driver operated, driver-less (e.g., autonomous vehicles), and/or partially autonomous vehicles. Memory may receive, store, and operate on sensor information, including using machine learning algorithms to analyze the sensor information.

According to embodiments, vehicle sensor information may be received relevant to a location of a roadway. Received sensor information may be operated upon by a machine learning algorithm for analysis, diagnosis, and/or control of operation of a vehicle. In particular, the received sensor information may be operated upon by a machine learning algorithm for analysis, diagnosis, and/or control of operation of a vehicle relevant to a particular location of a roadway. In such embodiments, the vehicle sensors may offer improved information and the sensor information operated upon by machine learning algorithms can be used to effectuate safer operation of vehicles relative to the particular location of a particular roadway.

In an example, a method can include receiving at a processing resource, sensor information associated with a vehicle and relevant to a location on a roadway. The vehicle may include a plurality of sensors. The sensor information can include data inputs to sensors associated with operation of the vehicle. Examples of sensors can include machine vision sensors (e.g., visual recognition (VR) sensors), velocity sensors, position sensors, steering sensors, braking sensors (e.g., force and pressure sensors), engine performance sensor, etc., associated with the vehicle. The information inputs to sensors may be stored in memory associated with the vehicle. The processing resource can have access to the sensor information stored in one particular or a plurality of memory resources. At least one accessible memory resource may also store a machine learning algorithm that can be used to analyze and operate upon the information received from the sensors and stored in memory. The processing resource is configured to execute instructions stored on the one or more accessible memory resources.

Memory resource can include multiple types of memory media (e.g., volatile and/or non-volatile) and can write data to the various memory resources. The data inputs that can be written to memory media can vary based on characteristics such as source, attributes, metadata, and/or information included in the data. Data inputs received by a memory resource can be written (e.g., stored) in a particular type of memory media based on attributes. For instance, a particular memory media type can be selected from multiple tiers of memory resources based on characteristics of the memory media type and the attributes of the data input. Characteristics of the memory media type can include volatility, non-volatility, power usage, read/write latency, footprint, resource usage, and/or cost.

For example, non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such PCRAM three-dimensional cross-point memory (e.g., 3D XPoint™, RRAM, FeRAM, MRAM and programmable conductive memory, among other types of memory. Volatile memory can require power to maintain its data (e.g., host data, error data, etc.) and includes RAM, DRAM, and SRAM, among others. The characteristics of different memory resources can include features that cause tradeoffs related to performance, storage density, energy requirements read/write speed, cost, etc. In some examples, some memory resources may be faster to read/write but less cost effective than other memory resources. In other examples, memory resources may be faster but consume a large amount of power and reduce the life of a battery, other memory media types can be slower and consume less power. As hosts such as mobile devices, semi-autonomous vehicles, fully autonomous vehicles, mobile artificial intelligence systems, etc. become more prevalent, sensors and other devices related to computing systems and hosts are also increasingly prevalent. The sensors can produce frequent and/or large quantities of data which can be used by a computing system, a host, and/or a user interface corresponding to a host, to make decisions related to the operation of the host. Balancing the tradeoffs between various different memory media types to store the frequent and/or large quantities of data can be an important endeavor

Embodiments herein may allow a processing resource to receive sensor information from a sensor associated with a vehicle relevant to a location on a roadway. The received sensor information may be operated on using a machine learning algorithm stored in a memory accessible by the processing resource. The operated upon information may be used to generate and transmit instructive actions to the vehicle and/or to subsequent vehicles on the roadway. For example, a driver of a vehicle and/or an autonomous vehicle may receive sensor information that due to thick fog in a first location relevant to a location on a roadway, visibility is poor. The information regarding the thick fog can be operated upon using a machine learning algorithm stored in a memory accessible by the processing resource. Based on that, the first vehicle may receive instruction to reduce speed from 45 mph to 10 mph. In some embodiments, the received sensor information can be used to determine if the information received is analogous to other information received about the location relevant to the roadway via machine learning algorithms. As described herein, the term “machine learning” refers to a process by which a computing device is able to improve its own performance through iterations by continuously incorporating new data into an existing statistical model. Machine learning can facilitate automatic learning for computing devices without human intervention or assistance and adjust actions accordingly.

A memory system and/or a wireless connection point can include processing resource and memory resource to store data. A memory system controller can be a controller or other circuitry which is coupled to the memory system. The memory system controller can include hardware, firmware, and/or software to receive information about the incoming data and use that information for machine learning process to generate instructions.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “J,” “K,” “L,” “N,” “R,” “Q,” etc., particularly with respect to reference numerals in the drawings, indicate that a number of the particular feature so designation can be included. It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context and, unless stated otherwise, can include a wireless connection. The terms “data” and “data values” are used interchangeably herein and can have the same meaning, as appropriate to the context.

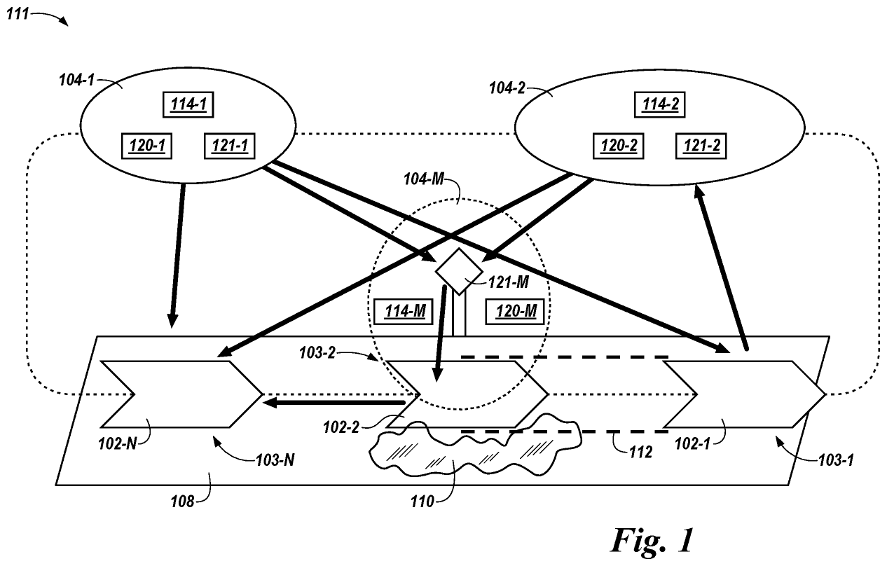

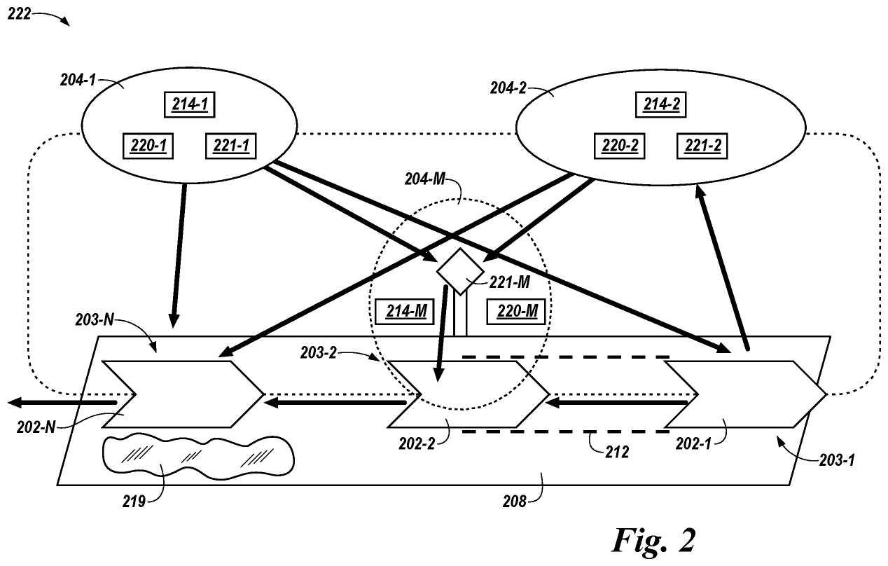

The figures herein follow a numbering convention in which the first digit or digits correspond to the figure number and the remaining digits identify an element or component in the figure. Similar elements or components between different figures can be identified by the use of similar digits. For example, 106 can reference element “06” in FIG. 1, and a similar element can be referenced as 206 in FIG. 2. A group or plurality of similar elements or components can generally be referred to herein with a single element number. For example, a plurality of reference elements 102-1 . . . 102-N can be referred to generally as 102. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

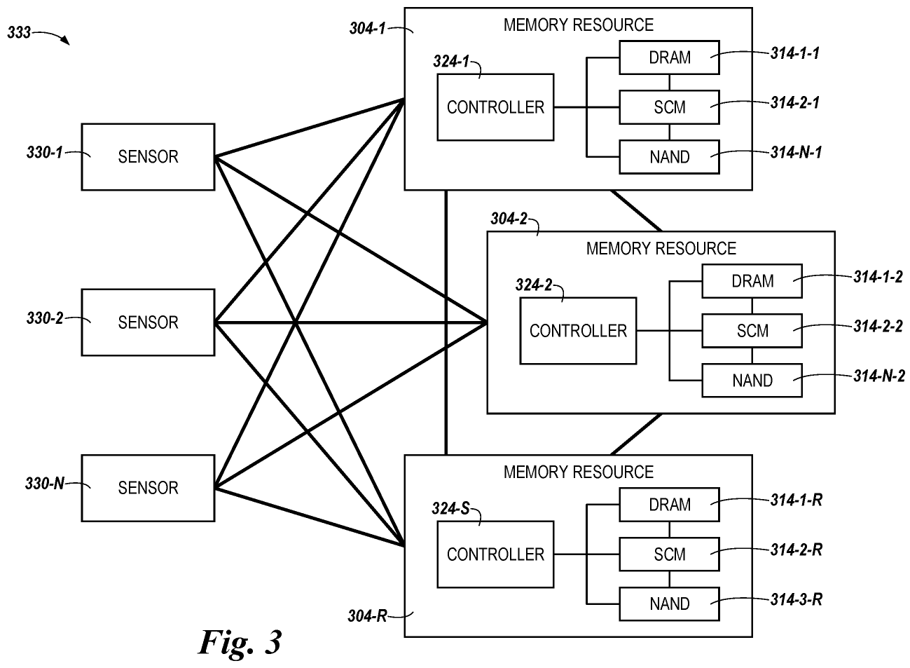

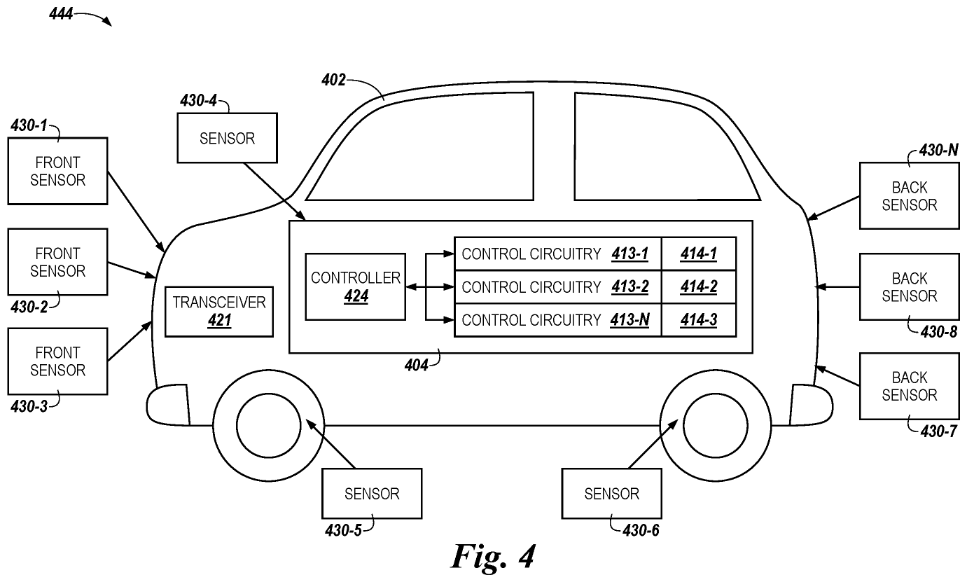

FIG. 1 illustrates a system 111 wirelessly connecting a plurality of vehicles 102-1, 102-2, . . . 102-N relevant to a location on a roadway 108 in accordance with a number of embodiments of the present disclosure. In some examples the plurality of vehicles 102-1, 102-2, . . . 102-N may be referred to collectively and/or independently as “vehicle(s) 102”. FIG. 1 illustrates a first vehicle 102-1, a second vehicle 102-2, and a third vehicle 102-N on a roadway 108. The first vehicle 102-1 is illustrated at a first particular location 103-1 on the roadway 108. The second vehicle 102-2 is illustrated at a second particular location 103-2 on the roadway 108. In some embodiments the any of the locations 10 can include a road condition such as an obstruction 110. The obstruction can include black ice, potholes, etc. The third vehicle 102-N is illustrated at a third particular location 103-M on the roadway 108. The vehicles 102-1, 102-2, . . . 102-N. can each include a host interface, a controller, (e.g., a processing resource), control circuitry, hardware, firmware, and/or software and a plurality of memory resources (e.g., a number of memory media devices) each including control circuitry (as described in connection with FIG. 3 and FIG. 4). The system 111 can include a plurality of wireless connection points, 104-1, 104-2 . . . 104-N, each having a processing resource and a memory resource (e.g., 120 and 114). In some examples the plurality of wireless connection points, 104-1, 104-2 . . . 104-N, may be referred to collectively and/or independently as “wireless connection point(s) 104”. The wireless connections may be similar or different from one another. For example, the wireless connection point 104-1 can include a cloud computing service, (e.g., a cloud computing resource such Amazon Web Service® (AWS®)). The wireless connection point 104-2 can include a satellite wireless service (e.g. OnStar®) or a satellite internet connection accessible for retrieving internet content and/or information (e.g., Google Maps®, etc.) The wireless connection point 104-M can include a carrier network base station located along a roadway and operated by a municipality and/or carrier network (e.g., Verizon®, etc.).

In a number of embodiments, the wireless connection point 104-1 can be a cloud computing service having a processing and memory resource 120-1 and 114-1, which may be wirelessly connected to a processing resource and a memory resource (shown in FIGS. 3 and 4) of the first vehicle 102-1, a processing resource and memory resource of the second vehicle 102-N, and a processing resource and memory resource of the third vehicle 102-N. The processing and memory resource of the wireless connection point 104-1 can be coupled to another wireless connection point 104-M (e.g., a base station as discussed below) having a processing resource and a memory resource. The wireless connection points 104-1 and 104-2 may include wireless network accessing resources from a third-party provider using wide area networking (WAN) or Internet-based access technologies (e.g., as opposed to wireless local area networking (WLAN)). In this example, the wireless network accessing resources can include improved Internet access and/or more reliable WAN bandwidth (e.g., suitable for using 5G wireless technology) which may enable processing of network management functions in the cloud. The processing resource 120-1 may provide management, connectivity, security, and/or control of the network. This may include distribution of wireless access routers or branch-office devices (e.g., in base stations 104-2, vehicles 102, etc.) with management in the cloud.

In a number of embodiments, the wireless connection point 104-2 can include a satellite wireless service having a processing and memory resource 120-2 and 114-2 coupled to a processing resource and a memory resource (shown in FIGS. 3 and 4) of the first vehicle 102-1, a processing resource and memory resource of the second vehicle 102-2, and a processing resource and memory resource of the third vehicle 102-N. Further, the processing and memory resource of the satellite wireless service 104-2 can be coupled to a processing resource and a memory resource of the wireless connection point 104-M (e.g., a base station to a carrier network).

In a number of embodiments, the wireless connection point 104-M can be a wireless base station having a base station processing and memory resource (not shown) coupled to a processing resource and a memory resource of the first vehicle 102-1, a processing resource and memory resource of the second vehicle 102-2, and a processing resource and memory resource of the third vehicle 102-N. According to embodiments discussed herein, the various processing and memory resources can be configured to share information relative to a particular location on the roadway between the wireless connection points and the first vehicle 102-1, second vehicle 102-2 and third vehicle 102-N.

In some examples, the plurality of wireless connections points, 104-1, 104-2 . . . 104-M and the first, second, and third vehicles, 102-1, 102-2 . . . 102-N, etc. may be wireless coupled (e.g., wirelessly connected using fifth generation (5G)) wireless technology. 5G may be designed to utilize a higher frequency portion of the wireless spectrum, operating in millimeter wave bands (e.g., 28, 38, and/or 60 gigahertz), compared to other wireless communication technologies (e.g., fourth generation (4G) and previous generations, among other technologies). The millimeter wave bands of 5G may enable data to be transferred more rapidly than technologies using lower frequency bands. For example, a 5G network is estimated to have transfer speeds up to hundreds of times faster than a 4G network, which may enable data transfer rates in a range of tens of megabits per second (MB/s) to tens of GB/s for tens of thousands of users at a time (e.g., in a shared memory resource) by providing a high bandwidth. The actual size of the memory resource, along with the corresponding bandwidth, may be scalable dependent upon the number of vehicles included in a shared memory resource, among other considerations described herein.

In some embodiments, received information about a particular vehicle's (e.g., 102-1, 102-2, 102-N, etc.) operation may be detected by one or more sensors and/or a plurality of sensors of a like or different types associated with a particular vehicle and stored in a memory resource in association with particular location on a roadway upon which the vehicle is traversing. As will be described in more detail herein, a plurality of sensors associated with a vehicle may be continuously detecting and storing, recording such as through an event detection recorder (EDR), information associated with a particular vehicle's operation, performance and travel. This information associated with a particular vehicle's operation, performance and travel may be referred to as being part of a vehicle's operational parameters. Regardless, of whether the vehicle is human operated, autonomous, or partially autonomous, information on the vehicle's operation may be continuously collected and stored to memory. As used herein the term “operation” is intended to mean aspects of control over a vehicle's movement and functioning and can include, acceleration, deceleration, braking, climate control, steering, fuel systems, entertainment, instrument and information display, audio and/or visual control, etc. The term “performance”, as used herein is intended to mean an evaluation of a level or rating on a spectrum of operation from “low” performance, which may be non-functioning, sub-optimal and/or poor functionality of a component, (e.g., vehicle component such as brake pads, fuel injectors, etc.) to “high” performance, which may be from adequate on up through acceptable, good, and/or even maximum attainable functional ability of the component.

According to embodiments of the present disclosure, stored sensor information associated with the operation and/or performance of a vehicle relative to a particular location in a roadway can be operated upon by machine learning algorithms to process, analyze, compare, predict, and to generate instructions to share information and/or direct operation of other vehicles relative to the particular location in the roadway. For example, machine learning algorithms can operate upon sensor information associated with the operation of a vehicle relative to a location and compare the received sensor information to sensor information received previously from the same vehicle at another occasion of the particular vehicle traversing that particular location of the roadway. Sensor information may also be operated upon by a machine learning algorithm to compare the received sensor information to sensor information received from other vehicles traversing that particular location of the roadway at a proximate time (e.g., relatively recent to the time of another), another distinct time (e.g., not recent to the time of another), a similar date, season, weather setting (e.g., temperature, dew point, humidity, wind velocity, precipitation, etc.).

In some embodiments, advanced machine learning algorithms programmed to evaluate, process, analyze, predict and to generate resultant instructions may be stored in one or more memory resources (e.g., 114-1) associated with a wireless connection point, such as cloud computing service 104-1, and can be executed by one or more processing resources, such as 120-1, associated with the wireless connection point, such as cloud computing service 104-1, to operate on received sensor information relative to a location of a roadway as received from one or more vehicles traversing the location on the roadway over time. The execution of the machine learning algorithms to operate on the received sensor information may be performed in a distributed computing environment or otherwise. Embodiments are not so limited. In some embodiments, at least a portion of available machine learning algorithms may be stored in one or more memory resources of a particular vehicle collecting the sensor information and executed by one or more processing resources associated with a host, of the vehicle in order to operate to some extent on the received sensor information. Embodiments, however, are not limited to these examples.

According to embodiments of the present disclosure, the plurality of wireless connections points, 104-1, 104-2 . . . 104-M and the first, second, and third vehicles, 102-1, 102-2 . . . 102-N may each include one or more transceiver resources to receive and transmit information wirelessly. As shown in the example of FIG. 1, in some embodiments, vehicle operation and/or performance information may be obtained by a sensor on a vehicle, 102-1, 102-2 . . . 102-N, relative to a location (e.g., 102-2), on a roadway 108. In this example, operation and performance information obtained by a sensor on a vehicle, 102-1, 102-2, . . . , 102-N relative to a location, (e.g., 102-2), on a roadway 108 may be information relative to a roadway condition 110 about a roadway hazard, such as an icy road patch related to weather conditions. In this example, the sensors on the vehicle sensing the operation and performance information may include wheel rotation and slippage sensors, machine vision sensors, steering sensors, braking sensors, etc. Embodiments, however, are not limited to this example of sensors or the type of roadway condition 110 relative to a location 103-1 on the roadway. The information may be stored in a memory resource of the vehicle and operated upon by a processing resource of the vehicle. The sensor information stored in the memory of the vehicle may also be stored with and operated upon in connection with additional information received by other sensors on the vehicle and/or wirelessly from another wireless connection point such as a satellite wireless connection point 104-2. The additional information may include GPS data on location, direction, etc., weather (e.g., including precipitation, dew point, etc.), date and time information, etc.

According to embodiments of the present disclosure, sensor information obtained, (e.g., detected) by the sensor and stored by a memory resource and/or operated upon by a processing resource of the vehicle may also be transmitted from the vehicle using a transceiver (discussed in connection with FIGS. 3 and 4) on the vehicle to a wireless connection point (e.g., cloud computing service 104-1). In some embodiments, the sensor information is received by a processing resource (e.g., 120-1) of the wireless connection point 104-1 and instructions may be executed to index and store the received sensor information in a memory resource (e.g., 114-1) of the wireless connection point 104-1 relative to the particular location, and/or time, date, weather and/or other information. In some embodiments the sensor information can similarly be indexed and stored to a memory resource of the vehicle. The received sensor information may be stored on the memory resource together with sensor information received previously and/or subsequently, relative to the particular location 103-2 on the roadway 108, from the same vehicle and/or other vehicles and at a proximate time, different time, date, weather, and/or season information. In some embodiments, a machine learning algorithm, including instructions executed by the processing resource 120-1, can operate on the stored sensor information data to process, analyze, compare, and/or to generate instructions, continuously or according to a particular interval, such as a “new” information is received relative to the particular location 103-2. According to embodiments, instructions generated by operation of the machine learning algorithm upon sensor information relative to the location 103-2 in the roadway may be transmitted by a transceiver resource 121-2 of the wireless connection point 104-2 to other wireless connection points (e.g., 104-1, 104-M) and/or vehicles 102-2, . . . , 102-N. The transmitted instructions may be received by the other wireless connection points (e.g., 104-1, 104-M) and/or vehicles 102-1, 102-2 . . . 102-N, and/or retransmitted for informational purposes and/or to change adjust, operational parameters on another vehicle, (e.g., a vehicle 102-2) which may be presently encountering the roadway condition 110, (e.g., icy) roadway, at the particular location 103-2 or a vehicle 102-N approaching the roadway condition 110. As such, the other vehicle 102-2 . . . 102-N, may change operational parameters, based on received information and instructions, whether a human operated vehicle, autonomous vehicle, or partially autonomous vehicle.

In some embodiments, received sensor information operated upon by a machine learning algorithm relative to a location 103-2 on a roadway 108 can be shared directly between the first vehicle 102-1, second vehicle 102-2, third vehicle 102-N. For example, processing resource of the first vehicle 102-1 can access information stored in a memory resource of the first vehicle 102-1. Further, the processing resource of the first vehicle 102-1 may access information stored in a memory resource of the second vehicle 102-2 and transfer that information to the first vehicle 102-1. For example, the first vehicle can 102-1 can determine that the second location 103-2 is free of construction while driving during a particular period of time (e.g., 11 pm to 5 am) period. However, the second vehicle 102-2 can receive sensor information, operated upon by a machine learning algorithm, from the memory resource of the second vehicle 102-2 that the second location on the roadway 108 is under construction during that particular period of time.

As noted above, the sensor information that is received may be sensor information that has been operated upon or is being operated upon by a machine learning algorithm. Based on the operated upon sensor information, the second vehicle and/or first vehicle can take an action. For example, the sensor information operated upon by the machine learning algorithm may predictive and/or preventative and instructions can be generated and executed to change an operational parameter of the second and/or first vehicle(s). According to some embodiments, the sensor information can use sensor information operated upon by the machine learning algorithm, received in current time with sensor information received in different periods of time received via a plurality of sensors and by different vehicles relative to the location on the roadway, to take a preventative action.

As described herein, the sensor information about the first vehicle can be transmitted via a transceiver coupled to the vehicle 102. Some examples of sensors can include temperature devices, camera devices, video devices, machine vision devices, charge coupling devices (CCDs), audio devices, motion devices, Internet of Things (IoT) enabled devices, vehicle electronic control unit (ECU) devices, thermostats, security systems, etc.), a torque sensor, a wheel speed sensor, a crank sensor, a pressure sensor, a friction sensor among others. The information obtained by the sensors may be received by and stored by memory resource associated with a wireless connection point 104. A plurality of memory resource types (e.g., DRAM, SCM, and NAND) may be associated with the processing resources 120 to receive data from the plurality of vehicles 102-1, 102-2, 102-N.

A first wireless connection point 104-1 can transmit, (e.g., share) received sensor information from the first vehicle 102-1, that has been operated upon by a machine learning algorithm, to the second connection wireless point 104-2. The second wireless connection point 104-2 can further transmit the received information from the first wireless connection point 104-1 to the third wireless connection point 104-M, etc. In the example above, information about the road construction can be received via the first wireless connection point 104-1, which can then be broadcast to the second wireless connection point 104-2 and the information can be transmitted to a third vehicle 102-N, for example, that is approaching the second location 103-2. As such, a vehicle may take a preventative action to change operational parameters and avoid the road construction. Embodiments are not limited to this example.

As illustrated in FIG. 1, the wireless connection points 104 receive a sensor information about vehicles and relevant to a location on a roadway 108. As used herein, the term “sensor information” refers to information revived from the sensor about the vehicle and/or conditions surrounding the vehicle. Sensor information may include acceleration of a vehicle, de-acceleration a vehicle, velocity of the vehicle, change in steering of the vehicle, temperature of the location of the roadway relevant to the vehicle, dewpoint of the location, season of the year, etc. For example, the processing resource 120-1 can receive, via a sensor associated with the second vehicle 102-2, a sudden deceleration in speed in response to the second vehicle 102-2 driving through the second 103-2 location on the roadway 108. In addition to the information about the speed, the wireless connection point 104-1 can receive sensor information of the second vehicle 102-2 an image of an environmental condition of the first location (e.g., heavy fog, heavy rain, etc.). The information can be received from the same and/or a different sensor. In some instances, the wireless connection point 104-1 may not receive the environmental information from the sensor and may receive only information that the second vehicle 102-2 decelerated in speed during a first time period. Similarly, the wireless connection point 104 may receive road construction information of the roadway 108 at the second location 103-2 at a first period of time. The memory resource associated with the wireless connection point 104-1 can save that information to use at a later time. Alternatively, the wireless connection point 104-1 can use the information in current time to determine an instructive action for the vehicle 102-2, as further described herein.

The wireless connection points 104-1, 104-2, 104-M can receive the sensor information about the first vehicle 102-1 that may include information associated with a change in operational parameter of the first vehicle 102-1. For example, the first wireless connection point 104-1 can receive sensor information associated with the first vehicle 102-1. The change in operational parameter may include, but is not limited to, change in speed, change in velocity, change in steering pattern, change in force, etc. The change in operational parameter of the first vehicle 102-1 can be received by the first wireless connection point 104-1, the second wireless connection point, 104-2, and/or the third wireless connection point 104-M. The received information about the change in operational parameter can be processed by using a machine learning algorithm, as further described herein. The first connection point 104-1, for example, can receive information about the change in operational parameter of the vehicle 102-1 instantaneously and transmit an instructive action to the second vehicle 102-2 to the changed operational parameter of the vehicle 102-2. For example, first connection point 104-1 can receive a change in speed in the first vehicle 102-1 at the first location 103-1 and based on that transmit instructive action to the second vehicle 102-2 to slow down at the first location 103-1 In some embodiments, the first vehicle 102-1 can receive sensor information about the operational parameters of the vehicle 102-1 and compare the information received in different periods of time via also processed via the machine learning algorithm.

In some embodiments, the first wireless connection point 104-1 and/or the second wireless connection point 104-2 can receive changed sensor information responsive to a change in received sensor information over time relevant to the location on the roadway 108. For example, on a first day of spring a sensor information about a second location 103-2 on the roadway 108 can be received as clear and a third location 103-M can be received as covered with black ice on the surface. On a fifth day of spring, a sensor information about the second location 103-2 can be received as covered with black ice 110 on the surface. Based on the road condition change on location 103-2, the first wireless connection point 104-1, for example, can operate on the information, via machine learning, and instruct a vehicle to take an action, as further describe herein.

The wireless connection points 104 can receive sensor information about the vehicles 102 and operate on the received information using a machine learning algorithm. For example, the wireless connection point 104-2 may determine a received sensor information is an incident on a particular location on the roadway 108. In such instances, the machine learning algorithm may generate an instructive action that is predictive based on previous experiences, received in different periods of time. For example, the first wireless connection point 104-1 can receive information that the first location 103-1 has a depression (e.g., pothole) on the roadway 108 and broken pieces of the pavement. Based on that, the first wireless connection point 104-1 can compare with previous years road construction data of that particular location (e.g., 103-1) during that time period and determine an instructive action to take an alternative route. Alternatively, the first wireless connection point 104-1 may determine that the received information is received for the first time. In such instances, the machine learning algorithm may generate an instructive action to send an alert.

The wireless connection points 104 can transmit instructions relevant to the location based on the sensor information associated with the first vehicle 102-1 that was operated upon by the machine learning algorithm. The wireless connection point resource 104-1 can transmit instructions relevant to a second location 103-2 based on the received and the operated upon sensor information from the first vehicle 102-1.

In some embodiments, an instructive action for a second vehicle 102-2 can be based on the operated upon sensor information about the first vehicle 102-1. For example, the wireless connection point 104-2 can receive sensor information from the first vehicle 102-1 on a second location 103-2 at first time period and have that sensor information stored and operated upon via a machine learning process on a continuous basis. The wireless connection point 104-2 can transmit instructions relevant to the location 103-2 to the second vehicle 102-2 the location 103-2 when the vehicle 102-N approaches the location 103-2. For example, the wireless connection point 104-2 can instruct an approaching vehicle 102-N to slow down in current time in response to receiving a sensor information about a detected depression (e.g., pothole) on the second location 103-2 on the roadway 108.

In some embodiments, the wireless connection points 104-1 can broadcast the instructive action via the base station 104-M responsive to the operational change of the first vehicle 102-1. For example, wireless connection point 104-1 may receive information that the first vehicle 102-1 experienced heavy fog while traveling through the first location 103-1 during a first time period. The wireless connection point 104-1 can operate on that information via machine learning process and transmit the information to the base station 104-M which can broadcast an instructive instruction to the second vehicle 102-2 passing the first location 103-1 in current time. Further, the base station 104-M can broadcast the instructive instruction, processed via the machine learning algorithm, to the third vehicle 102-N approaching the first location 103-1 at a future time and/or receive feedback as to whether the condition still exists.

In some embodiments, a transceiver resource 121-1 may be configured to wirelessly share data between at least two of a plurality of memory resources via a processing resource 120 coupled to each of the memory resources 114-1,114-2, 114-M etc. Each of a plurality of the memory resources may, in a number of embodiments, be on a corresponding plurality of vehicles (e.g., on each of the plurality of unitary vehicles 102. Each transceiver resource may include, in a number of embodiments, one or more radio frequency (RF) transceivers. A transceiver, as described herein, is intended to mean a device that includes both a transmitter and a receiver. The transmitter and receiver may, in a number of embodiments, be combined and/or share common circuitry. In a number of embodiments, no circuitry may be common between the transmit and receive functions and the device may be termed a transmitter-receiver. Other devices consistent with the present disclosure may include transponders, transverters, and/or repeaters, among similar devices. In a number of embodiments, the transceiver resource may be wirelessly couplable to a base station 104-M and/or a cloud processing resource 120-2 to enable formation of shared memory for machine learning algorithm.

In the example discussed in connection with FIG. 1, vehicles, 102 and wireless connection points 104 can each be referred to as hosts. Embodiments, however, are not limited to these examples of a “host”. In other embodiments a host system can include a personal laptop computer, a vehicle, a desktop computer, a digital camera, a mobile telephone, an internet-of-things (IoT) enabled device, or a memory card reader, graphics processing unit (e.g., a video card), among various other types of hosts. The example vehicles (e.g., 102, shown in FIG. 1) can include a system motherboard and/or backplane and can include a number of memory access devices and a number of processing devices (e.g., one or more processing resources, microprocessing resources, or some other type of controlling circuitry). One of ordinary skill in the art will appreciate that “a processing resource” can intend one or more processing resources in the form of transistors, Application Specific Integrated Circuits (ASICs), logic gates, etc. (all of which may also be referred to as “processing devices”). Processing resources can also include a parallel processing system having a plurality of processing devices operating together in an organized, structured manner as a number of coprocessing resources, etc.

As used herein an “IoT enabled device” can refer to devices embedded with electronics, software, sensors, actuators, and/or network connectivity which enable such devices to connect to a network and/or exchange data. Examples of IoT enabled devices include mobile phones, smart phones, tablets, phablets, computing devices, implantable devices, vehicles, home appliances, smart home devices, monitoring devices, wearable devices, devices enabling intelligent shopping systems, among other cyber-physical systems.

FIG. 2 illustrates a system 222 wirelessly connecting a plurality of vehicles relevant to a location of a roadway 208 in accordance with a number of embodiments of the present disclosure. FIG. 2 illustrates a first vehicle 202-1, a second vehicle 202-2, and a third vehicle 202-N on the roadway 208. The first vehicle 202-1 is illustrated at a first particular location 203-1 on the roadway 208. The second vehicle 202-2 is illustrated at a second particular location 203-2 on the roadway 208. Analogous to the system 111 illustrated relation to FIG. 1, System 222 can include a plurality of wireless connection points, 204-1, 204-2 . . . . 204-N, each having a processing resource and a memory resource (e.g., 220 and 214).

Although not illustrated in FIG. 2 as to not obstruct the examples of the disclosure, the vehicles 202-1, 202-2, 202-N can each include a host interface, a controller (e.g., a processing resource), control circuitry, hardware, firmware, and/or software and a plurality of memory resources (e.g., a number of memory media devices) each including control circuitry. In some embodiments, the first vehicle 202-1 can comprise a first sensor coupled with a first processing resource, and a first memory resource (as illustrated in relation to FIG. 3 and FIG. 4) communicatively coupled to the wireless connection point 204-1. A second vehicle 202-2 can comprise a second sensor, a second processing resource and a second memory resource communicatively coupled to the wireless connection point 204-1. In some embodiments, the wireless connection point 204-1 may receive a first sensor information about the first vehicle 202-1 and a second sensor information about the second vehicle 202-2 relevant to a location on the roadway 208. A third vehicle 202-M can comprise a third sensor, a third processing resource and a third memory resource communicatively coupled to the wireless connection point 204-1. In some embodiments, the wireless connection point 204-1 may transmit an alert to the third vehicle 202-M in response to determining a change in condition on the roadway 208 using a machine learning algorithm. According to embodiments of the present disclosure, condition in a particular location in a roadway can be dynamic and/or ever changing. The machine learning algorithm may process, analyze, compare, and/or to generate instructions, continuously about the particular location, including receiving “new” information relative to the particular location. For example, sensor information associated with a traversing first vehicle 202-1 may receive information that a particular first location 203-1 on the roadway 208 can have heavy deer traffic during a first time period (e.g., from 11:00 μm to 5:00 am) due to adjacent forestry. In contrast, the first location 203-1 on the roadway 208 may not have deer traffic during a second time period (e.g., 5:00 am to 11:00 pm). Based on that changing information about the roadway 208, stored by a memory resource of a wireless connection point (e.g., a base station 204-M) located along the first location 203-1 relevant to the roadway 208, a second vehicle 202-2, approaching the first location 203-1, can receive an instructive action to slow down and/or use an alternate route 212 during the first time period. In another example, the first vehicle 202-1 may receive sensor information for the first time about unusual and/or unexpected deer traffic on the first location 203-1. The information may be received by a wireless access point 204 from the first vehicle 202-1 and transmitted to a second vehicle 202-2 approaching the particular location 203-1 on the roadway 208. The memory resource of the second vehicle 202-2 may determine, based on results of the machine learned algorithm, instructions to operate upon received sensor information, that the deer traffic for that period of time is a new incident and may store that information to use and compare with information received at other periods of time.

In some embodiments, the change in condition on the roadway is determined based on the received first sensor information received from the first vehicle, and the received second sensor information received from the second vehicle, changing over time. For example, the first vehicle 202-1, associated with the first sensor (e.g., sensor 330-1 described in relation to FIG. 3) may receive sensor information that the first location 203-1 has a pothole during a first time period. The second vehicle 202-1, associated with the second sensor (e.g. 330-2 described in relation to FIG. 3) may receive sensor information that the first location 203-1 does not include a pothole during a second time period. Based on the newly received information about the pothole, the machine learning algorithm may predict that the pothole has been repaired and predict that the condition on the roadway has changed. As demonstrated by this example embodiment, the first sensor information and the second sensor information are operated upon by the machine learning algorithm, accessible by the wireless connection point, to continually update, predict, communicate and/or corrective instructions to influence or control actions of vehicles 202-1, 202-2, 202-N relative to locations 203-1, 203-2, 203-N.

FIG. 3 is functional block diagram in the form of a computing system 333 including a plurality of memory resources 304-1, 304-2, 304-R communicatively coupled with a plurality of sensors 330-1, 330-2, 330-N in accordance with a number of embodiments of the present disclosure. As used herein, the plurality of sensors 330-1, 330-2, 330-N may be collectively and/or independently referred to as the “sensor(s) 330” and be analogous to the sensors described in connection with FIG. 1. The plurality of memory resources 304-1, 304-2, 304-R may be collectively and/or independently referred to herein as “memory resource(s) 304” and be analogous to the memory system 104 described in connection with FIG. 1. Each of the memory resource(s) 304 can respectively include a controller (e.g., processing resource) 320-1, 320-2, and 320-S. The controller(s) 324-1, 324-2, and 324-S may be collectively and/or independently referred to herein as “controllers 324” and be analogous to the controller 120 described in connection with FIG. 1. Each of the controllers 324 can be communicatively coupled to a memory resource 304 (e.g., and various types of volatile and/or non-volatile memory devices 314-1-1, 314-1-2, . . . , 314-3-R).

For example, memory resource 304-1 can include controller 324-1 and memory devices 314-1-1, 314-2-1, and 314-N-1. Memory resource 304-2 can include controller 324-2 and memory devices 314-1-2, 314-2-2, . . . , 314-N-2 (e.g., DRAM device 314-1-2, SCM device 314-2-2, and NAND device 313-N-2). Memory resource 304-R can include controller 324-S and memory devices 314-1-R, 314-2-R, 314-3-R. Memory devices may be the same type of memory device and/or different memory device types (e.g., example, DRAM device 314-1-R, SCM device 314-2-R, NAND device 314-3-R, etc.). Embodiments are not so limited, however, and each memory system 304 can include any number and combination of memory devices.

The embodiment of FIG. 3 illustrates an example of a computing system 333 in which each sensor 330 is communicatively coupled to each memory resource 304, and each memory resource 304-1, 304-2, and 304-R is communicatively coupled to each other. Although not illustrated as to not obscure the examples of the disclosure, the sensors 330 and the memory resource(s) 304 can be communicatively coupled to a host (e.g., an autonomous vehicle).

In a non-limiting embodiment where the host is a vehicle, and a first sensor 330-1 is a camera sensor, a second sensor 330-2 is a temperature sensor, and a third sensor 330-N is acoustic sensor, the memory system 304 can receive information/data from all of the sensors 330. A first memory system 304-1 may be related to a braking system ECU of the vehicle and may have data attributes related to the camera sensor 330-1, the temperature sensor 330-2 or the acoustic sensor 330-N. In another example, a second memory system 304-2 may be related to a heating/cooling ECU and data from temperature sensor 330-2- and/or the acoustic sensor 330-N. In yet another example, a third memory device 304-R may be related to an ambient noise ECU a having information related to the acoustic sensor 330-N

Each of the controllers 324 can receive data from each of the sensors 330 as the sensors 330 generate the data. Each of the controllers 324 can store the data sequentially in a memory device and the controller 324, (e.g., a processing device) can execute instructions associated with a machine learning algorithm to iteratively compare and analyze the received sensor information (e.g., data). For example, the controller 324-1 can receive data from each of the sensors 330-1, 330-2, and 330-N. The controller 324-1 can determine information about sensor information where the information of the sensors 330 are related to a function, a location relative to the host, etc. For example, the controller 324-1, for example, can receive data from the camera sensor 330-1 and determine the sensor information is related to an image included in the data saved in memory device(s) 314-1. 318- and/or 316-1. Further, the memory resource 303-1 can compare the sensor information received in current time with sensor information (e.g., data), received in different periods of time and process it via machine learning. Based on that the host can receive an instructive action.

In another example, the controller 324-S can receive data from each of the sensors 330-1, 330-2, and 330-N. The controller 324-S can determine sensor information received from host where the information is related to an acoustic function of the sensors 330. Specifically, the controller 324-S can receive sensor information from the sensor 330-N (e.g., an acoustic sensor) and determine the information about the sensor information is related to audio information included in the data. The controller 324-S can compare the audio information received in current time with audio information received in different periods of time and process the information via machine learning. Based on that the host can receive an instructive action.

FIG. 4 is a diagram of a computing system 444 including a memory resource 404 deployed on a host 402 in the form of a vehicle in accordance with a number of embodiments of the present disclosure. The host 402 can include a host controller 424 which can be analogous to controller 324 described in connection with FIG. 3. The host 402 can be communicatively coupled to sensors 430-1, 430-2, 430-3, . . . , 430-7, 430-8, 430-N which can be collectively and/or independently referred to as the “sensor(s) 430” and be analogous to sensors 330 described in connection with FIG. 3. The memory resource 404 can be analogous to memory resource 114 described in connection with FIG. 1 and include a plurality of media devices. The memory resource 404 can include a memory device 414-1 (e.g. DRAM) including control circuitry 4131 a memory device 414-2 (e.g., SCM) including control circuitry 413-2, and/or a memory device 413-3 (e.g., NAND) including control circuitry 413-N. Embodiments are not so limited, however, and memory system 404 can include any number or combination of memory devices (e.g., non-volatile and/or volatile).

The example host 402 is in the form of a vehicle. A vehicle may include a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, and/or anything used for transporting people and/or goods. The sensors 430 are illustrated in FIG. 4 as including their attributes. For example, sensors 430-1, 430-2, and 430-3 can be camera sensors collecting data from the front of the vehicle host 420. Sensors 430-4, 430-5, and 430-6 are microphone sensors collecting data from the from the front, middle, and back of the vehicle host 402. The sensors 430-7, 430-8, and 430-N are camera sensors collecting data from the back of the vehicle host 420.

The host controller 424 can be a controller designed to assist in automation endeavors of a vehicle host 402. For example, the host controller 424 can be an advanced driver assistance system controller (ADAS). An ADAS can monitor data to prevent accidents and provide warning of potentially unsafe situations. For example, the ADAS may monitor sensors in a vehicle host 402 and take control of the vehicle host 402 operations to avoid accident or injury (e.g., to avoid accidents in the case of an incapacitated user of a vehicle). A host controller 424 such as an ADAS may need to act and make decisions quickly to avoid accidents. The memory resource 404, (e.g., memory system), can store reference data in memory devices such that new data received from the sensors 430 can be compared to the reference data such that quick decisions can be made by the host controller 424.

The reference data stored in the memory resources can be data that the host controller 424 has determined is relevant to the host 402. Reference data may be data aggregated from sensors 430 over a period of time. For example, the reference data associated with the front sensors 430-1, 430-2, 430-3 can include data collected of a route frequently traversed by the vehicle host 402. In this way, when the vehicle host 402 is traveling forward, the front sensors 430-1, 430-2, and 430-3 can transmit information to the host controller 424. The host controller 420 can compare and/or analyze the new data received to reference data stored, process by executing instructions associated with a machine learning algorithm and, based at least in part on the comparison and/or analysis, determine an instructive action. The Instructive action may include predictive action, based new information being received for the first time relevant to the location of the vehicle on the roadway. The instructive action may include a preventative action based on previous experience received in different periods of time relevant to the location of the vehicle on the roadway.

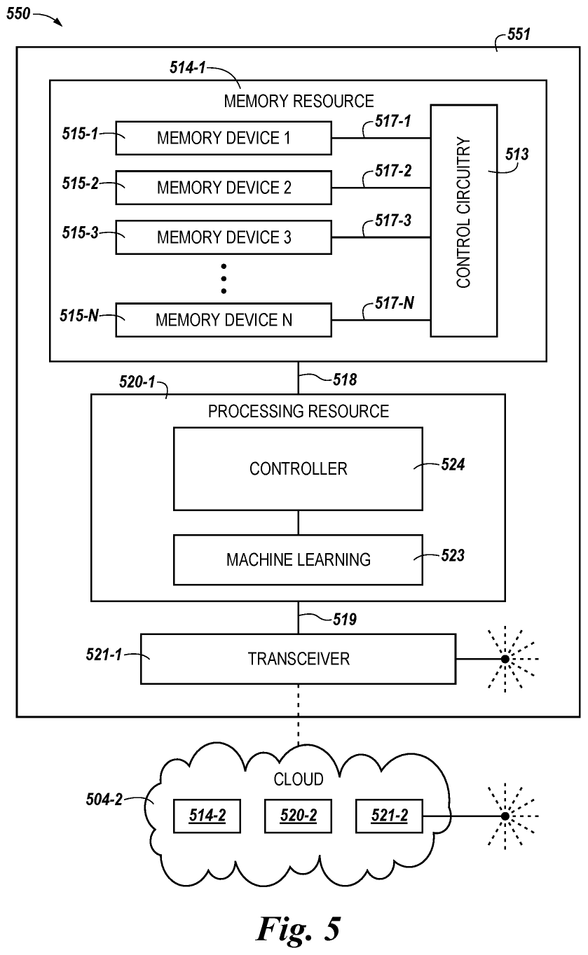

FIG. 5 is a block diagram illustrating an example of a system 550 for sharing sensor information stored in a memory resource 514 between hosts 551, including wireless connection points (e.g., such cloud computing service 504-2), in accordance with a number of embodiments of the present disclosure. In some embodiments a “host” can include a vehicle (e.g., vehicles 102-1, 102-3 . . . 102-N in FIG. 1) having processing and memory resources as described above in connection with FIGS. 1-4. In a similar manner, a cloud computing service (e.g., 104-2 in FIG. 1) having processing and memory resources, 520-2 and 514-2 may be referred to as a “host”. Embodiments, however, are not limited to these two examples of hosts. In other examples, a host 551 may include a laptop, a mobile phone, an electronic wearable device, an Internet of Things (IoT) enabled device such as a digital home assistant, etc.

As shown in the example of FIG. 5, the wireless connection point 504-2 includes a transceiver resource 521-2 to receive and transmit information such as sensor information relevant to a location on a roadway and/or instructions relevant to sensor information which has been operated upon using machine learning algorithms. The system 550 of FIG. 5 can represent an embodiment of one implementation of a combination of various resources, (e.g., a wireless connection) between a cloud computing service 504-2 and a vehicle host 551. In this example, the host 551 may represent an embodiment of an “apparatus” as described herein, although such apparatuses may include more or fewer elements than shown in FIG. 5. Wireless connection point 504 may represent an example of a wireless connection point to another host, which may be utilizable in combination to enable sharing sensor information between a cloud computing service and a vehicle. As shown in the example of FIG. 5, a host 551 can include a memory resource 514-1 coupled to 518 a processing resource 520 and coupled to 519 a transceiver 521-1. As shown, a memory resource 514-1 can include access to a plurality of memory devices, 515-1, 515-2, 515-3 . . . 515-N, which may be different and/or like memory media types and a memory resource 514 associated with one host 551 may be different and/or like another memory resource 514-2 associated with another host 504-2 (e.g., a first memory resource and a second memory resource). In some examples, the plurality of memory devices, 515-1, 515-2, 515-3 . . . 515-N, may be collectively and/or independently referred to as “memory device(s) 515”. For clarity, one memory resource and another memory resource may be distinguished from each other as a first memory resource and a second memory resource denoted respectively by reference numbers 514-1, 514-2 . . . 514-N. Similarly, one processing resource and another processing resource may be distinguished from each other as a first processing resource and a second processing resource denoted respectively by reference numbers 520-1, 520-2, etc. Other components presented herein may be similarly distinguished. In some examples, memory resources may be collectively and/or independently referred to as “memory resource(s) 514” and processing resources may be collectively and/or independently referred to as processing resource(s) 520″. As described herein, embodiments are not limited to two memory resources 514 and/or two processing resources 520 shown in the example of FIG. 5, and a corresponding number of other components may be included in sharing sensor information (not shown for clarity).

A “memory resource” as used herein is a general term intended to at least include memory (e.g., memory device) having memory cells arranged, for example, in a number of bank groups, banks, bank sections, subarrays, and/or rows of a number of memory devices. The embodiment of the memory resource 5144 illustrated in FIG. 5 is shown to include, by way of example, a plurality of memory devices 515-1, 515-2, . . . , 515-N. The memory resource 5144 may be or may include, in a number of embodiments, a number of volatile memory devices formed and/or operable as RAM, DRAM, SRAM, SDRAM, and/or TRAM, among other types of volatile memory devices. Alternatively or in addition, the memory resource 5144 may be or may include, in a number of embodiments, a number of non-volatile memory devices formed and/or operable as NAND, NOR, other Flash memory devices, PCRAM, RRAM, FeRAM, MRAM, STT RAM, phase change memory, and/or 3DXPoint, among other types of non-volatile memory devices.

Each memory device 515 may, in a number of embodiments, represent a memory device on which a number of bank groups, banks, bank sections, subarrays, and/or rows are configured (e.g., dedicated and/or programmable) to store data values (e.g., instructions) for performance of a particular functionality, (e.g., a steering, braking, acceleration, audio, visual, etc.) operation of a vehicle. Each functionality may include storage of data values to direct performance of a number of operations that contribute to performance of the functionality, for example, operational parameters to a human operated, autonomous, or partially autonomous vehicle. By way of example and not by way of limitation, such functionalities may include steering a vehicle (e.g., a unitary vehicle and/or a transport vehicle) to reach an intended destination, steering the vehicle to avoid obstructions, obeying traffic signals, and/or enabling the formation of a memory pool between the memory resource 514 formed and/or positioned on the vehicle and at least one other memory resource 513 formed and/or positioned on another vehicle, among many other possibilities for functionalities to be stored by the memory devices 515 of the memory resource 513 related to vehicles or other implementations.

Each of the plurality of memory devices 515-1, 515-2, . . . , 515-N of the memory resource 5144 may be coupled via a corresponding plurality of channels 517-1, 517-2, . . . , 517-N to control circuitry 514 for the memory resource 514. The plurality of channels 517-1, 517-2, . . . , 517-N may be selectably coupled to control circuitry 514 of the memory resource 514. The control circuitry 514 may be configured to enable data values for and/or instructions (e.g., commands) related to performance of a particular functionality to be directed to an appropriate one or more of the plurality of memory devices 515-1, 515-2, . . . , 515-N.

In a number of embodiments, the data values and/or instructions may be retrieved from a memory resource 514 and operated on by a processing resource 520-1. The processing resource 520-1 may include a controller 524 to provide commands and organize the execution of instructions upon information, (e.g., data) retrieved from the memory resource 514. As shown in the example of FIG. 5, the processing resource 520-1 can retrieve a machine learning algorithm 523 and execute instructions to cause the machine learning algorithm 523 to operate upon sensor information, received from one or more sensors and one or more vehicles relative to a location on a roadway as described herein. The processing resource 520-1 may execute instructions to operate on sensor information/data received from the memory resource 514-1 via a bus 518. The bus 518 may include a number of I/O lines sufficient for retrieving information, (e.g., data) from a memory resource 514-1 and/or for input of data to the memory resource 514-1 and/or output of data from the memory resource 514-1 for execution by the processing resource 520 (e.g., in performance of the various functionalities).

The controller 524 of the processing resource 520-1 may include and/or be physically associated with (e.g., be coupled to) a number of additional components (not shown) configured to contribute to operations controlled (e.g., performed) by the controller 524.

Each memory resource 514 may, in a number of embodiments, be coupled to a respective processing resource 520 configured to send and/or receive a sensor information via a transceiver to another vehicle and/or wireless connection point as the same has been described herein. Alternatively or in addition, each memory resource 514 may be coupled to a respective processing resource 520 configured to operate upon the sensor information using machine learning algorithm and transmit an instructive action from the processing resource of another memory resource. For example, in a number of embodiments, each memory resource on a vehicle may, in a number of embodiments, be coupled to a respective processing resource 520 configured to both send a and receive sensor information from sensors associated with the vehicle and operate upon the received sensor information using machine learning algorithm and transmit an instructive action to a processing resource 520 on another vehicle. In some embodiments, however, particular vehicles may be configured to only receive sensor information and share with other wireless connection points and/or memory resources for the formation of a memory pool and/or to respond to a request for formation of the memory pool.

In a number of embodiments, a first memory resource 514-1 and a second memory resource 514-2 each may include at least one volatile memory device 514 (e.g., in a DRAM configuration, among other possible configurations of volatile memory) coupled to a respective processing resource 520 configured to wirelessly share data. Alternatively or in addition, a first memory resource 514-1 and a second memory resource 514-2 each may include at least one non-volatile memory device 514 (e.g., in a NAND configuration, among other possible configurations of non-volatile memory) coupled to a respective processing resource 520 configured to wirelessly share data.

The processing resource 520 may, in some embodiments, execute instructions to change an operational profile created by execution of a machine learned algorithm. For example, an change in operational profile for a vehicle may be controlled by commands from a controller 524. The profile may be stored by and/or accessible (e.g., for performance of read and/or write operations directed by the controller 524) in, for example, in memory (e.g., SRAM) (not shown) of the processing resource 520. Alternatively or in addition, an operational profile may be stored by the memory resource 514 (e.g., in one or more memory device 515) and may be accessible (e.g., via bus 518, control circuitry 513, and/or channels 517) by the controller 524 of the processing resource 520 for performance of read and/or write operations.

As such, a change in operational parameters may, in a number of embodiments, be executed according to commands directed from a controller 524 of the processing resource 520 in performance of various functionalities. Continuous sensor information may be received and stored on the memory resource 514 (e.g., in one or more memory devices 515 of the memory resource 514). The memory resource 514 may be selectably coupled to a number of hardware components (e.g., positioned and/or formed as parts of a vehicle) configured to perform actions to accomplish an instructive action and consistent with the functionalities stored on the memory resource 514. On a vehicle, such hardware components may include hardware to, for example, enable steering, braking, and/or acceleration of the transport vehicle in response to receiving instructive action.

As such, a processing resource 520 for a memory resource 514 on a first vehicle may send a request (e.g., automatically and/or in response to a directive from a human driver) to processing resources on a second vehicle for access to a number of memory resources that enable sharing information to improve functionalities to enable accomplishment of the instructive action based on machine learning algorithm. The second vehicle may be located within a proximity of the intended route or potential alternative routes. In a number of embodiments, the sensor information (e.g., data) may be provided by (e.g., sent from) a number of wireless connection points (e.g., base stations as shown at 104-M and 204-M and described in connection with FIGS. 1 and 2, respectively) and/or infrastructure (e.g., houses, police/fire/news stations, businesses, factories, roadways etc., located within a proximity of the intended route or potential alternative routes.

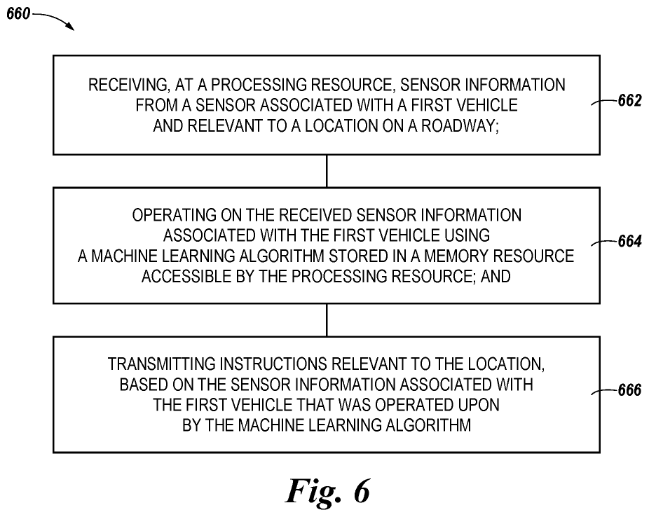

FIG. 6 is flow diagram representing an example method 660 of machine learning with sensor information relevant to a location of a roadway in accordance with a number of embodiments of the present disclosure.

At block 662, the method 660, can include instructions at a processing resource, receive sensor information from a sensor associated with a first vehicle and relevant to a location on a roadway. The processing resource is wirelessly connected to the first vehicle and configured to execute instructions stored on a memory resource to receive the sensor information based on the vehicle experiencing a change in the operational parameter. The change in operational parameter can include, but not limited to, change in speed, change in velocity, change in steering pattern, change in force.

In some embodiments, the processing resource is configured to execute instructions stored on the memory resource to receive sensor information about the vehicle relevant to the location of the roadway at different periods in time. For example, the sensor information about the vehicle (e.g., first vehicle 102-1, as illustrated in FIG. 1) can be received relevant to a first location (e.g., 103-1 as illustrated in FIG. 1) of a particular roadway during a first time period, a second time period and a third time period (e.g. in 24-hour iteration). The machine learned data can be transmitted from the first vehicle to a second vehicle machine learned data from the first vehicle to the second vehicle via a base station.

At block 664, the method 660, can transmit instructions to operate on the received sensor information associated with the first vehicle using a machine learning algorithm stored in a memory accessible by the processing resource. Operating on the received sensor information may include creating a statistical model based on information patterns and inference. For example, if the road conditions of the first location is icy at the same time of the day for during the winter months, and a plurality of accident information is received for that location during that time, the machine learning process can operate on that received information.

At 666, the method 660, can include instructions to transmit instructions relevant to the location, based on the sensor information associated with the first vehicle that was operated upon by the machine learning algorithm. The instruction can include instructive actions. For example, the processing resource can be configured to execute instructions stored on the memory resource to selectably determine a predictive action by comparing the operated upon sensor information in the current time with sensor information received at the different periods in time. Similarly, the processing resource can be configured to execute instructions stored on the memory resource to selectably determine a preventative action by comparing the operated upon sensor information in the current time with sensor information received at the different periods in time.

In some embodiments, the processing resource can be configured to execute instructions stored on the memory resource to alert a subsequent vehicle responsive to the subsequent vehicle approaching the location of the roadway. For example, an alternative route can be shown to a subsequent vehicle that is approaching the particular location on the roadway the first vehicle, has traveled, as described above.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, at a processing resource, sensor information from a sensor associated with a first vehicle and relevant to a location on a roadway;
operating on the received sensor information associated with the first vehicle using a machine learning algorithm stored in a memory resource accessible by the processing resource; and
transmitting instructions relevant to the location, based on the sensor information associated with the first vehicle that was operated upon by the machine learning algorithm.

2. The method of claim 1, wherein receiving, at the processing resource, sensor information comprises receiving sensor information at the processing resource wirelessly connected to the first vehicle.

3. The method of claim 1, further comprising generating an instructive action direct to a second vehicle based on the operated upon sensor information by the first vehicle.

4. The method of claim 1, comprising the receiving sensor information in current time and comparing with a plurality of sensor information in different periods of time.

5. The method of claim 1, comprising transmitting machine learned data from the first vehicle to the second vehicle via a base station.

6. The method of claim 5, comprising broadcasting the instructive action via the base station responsive to a change in operational parameters of the first vehicle.

7. The method of claim 1, further comprising receiving, at the processing resource, a changed sensor information responsive to a change in sensor information received over time relevant to the location on the roadway.

8. A system, comprising
a vehicle;
a sensor having access to a processing resource configured to execute instructions on a memory resource to transmit a sensor information relevant to a location on a roadway from the vehicle in current time; and
the processing to:
receive the sensor information about the vehicle and relevant to the location on the roadway; and
transmit instructions, relevant to the location, based on the sensor information about the vehicle being operated upon by a machine learning algorithm.

9. The system of claim 8, wherein the processing resource is wirelessly connected to the vehicle and configured to execute instructions stored on the memory resource to receive the sensor information based on the vehicle experiencing a change in operational parameters.

10. The system of claim 8, wherein the processing resource is configured to execute instructions stored on the memory resource to receive sensor information about the vehicle relevant to the location of the roadway at different periods in time.

11. The system of claim 10, wherein the processing resource is on the vehicle and is configured to execute instructions stored on the memory resource to selectably determine a predictive action by comparing the operated upon sensor information in the current time with sensor information received at the different periods in time.

12. The system of claim 10, wherein the processing resource is configured to execute instructions stored on the memory resource to selectably determine a preventative action by comparing the operated upon sensor information in the current time with sensor information received at the different periods in time.

13. The system of claim 8, wherein the sensor includes an image sensor, an audio sensor, a video sensor, a temperature sensor, an electronic control unit (ECU) sensor, a torque sensor, a wheel speed sensor, a crank sensor, a pressure sensor, a friction sensor or combinations thereof.

14. The system of claim 8, wherein the processing resource is configured to execute instructions stored on the memory resource to directly alert a subsequent vehicle responsive to the subsequent vehicle approaching the location of the roadway.

15. A system, comprising:
a wireless connection point;
a first vehicle, comprising a first sensor having a first processing resource, and a first memory resource communicatively coupled to the wireless connection point;
a second vehicle, comprising a second sensor, a second processing resource and a second memory resource communicatively coupled to the wireless connection point;
the wireless connection point to receive a first sensor information about the first vehicle and a second sensor information about the second vehicle relevant to a location on the roadway;
a third vehicle, comprising a third sensor, a third processing resource and a third memory resource communicatively coupled to the wireless connection point, wherein the wireless connection point transmits an alert to the third vehicle in response to determining a change in condition on the roadway using a machine learning algorithm.

16. The system of claim 15, wherein the change in condition on the roadway is determined based on the received first sensor information and received the second sensor information changing over time.

17. The system of claim 16, wherein the first sensor information and the second sensor information are operated upon by the machine learning algorithm accessible by the wireless connection point.

18. The system of claim 16, wherein the wireless connection point is configured to selectably determine the first sensor information received from the first sensor, the second sensor information received from the second sensor, and the third sensor information received from the third sensor shared between the first memory resource of the first vehicle, second memory resource of the second vehicle, and the third memory resource of the third vehicle.

19. The system of claim 15, wherein the wireless connection point receives the first the second and the third sensor information via a base station communicatively coupled to the first vehicle, the second vehicle, and the third vehicle.

20. The system of claim 15, wherein the, the first memory resource, the second memory resource, and the third memory resource are configured to wirelessly share the first sensor information, the second sensor information, and the third sensor information between the first vehicle, the second vehicle and the third vehicle.
